(19) United States
(12) Patent Application Publication
(10) Pub. No.: US 2020/0074593 A1
(43) Pub. Date: Mar. 5, 2020

(54) PANORAMIC IMAGE MAPPING METHOD, APPARATUS, AND DEVICE

(71) Applicant: PEKING UNIVERSITY SHENZHEN GRADUATE SCHOOL, Shenzhen (CN)

(72) Inventors: Ronggang WANG, Shenzhen (CN); Yueming WANG, Shenzhen (CN); Zhenyu WANG, Shenzhen (CN); Wen GAO, Shenzhen (CN)

(21) Appl. No.: 16/558,870

(22) Filed: Sep. 3, 2019

Related U.S. Application Data
(63) Continuation-in-part of application No. 16/490,373, filed on Nov. 21, 2019.

(30) Foreign Application Priority Data
Mar. 1, 2017 (CN) 201710116888.9

(51) Int. Cl. G06T 3/40; H04N 19/182; G06T 3/00; H04N 19/146

(52) U.S. Cl. CPC G06T 3/4038; H04N 19/182; H04N 5/23238; G06T 3/4007; H04N 19/146; G06T 3/0018

(57) ABSTRACT

Disclosed are a panoramic image mapping method, apparatus, and device. The method comprises: obtaining a to-be-mapped panoramic image; splitting the to-be-mapped panoramic image into three areas according to a first latitude and a second latitude, wherein the area corresponding to a latitude range from −90° to the first latitude is referred to as a first area, the area corresponding to a latitude range from the first latitude to the second latitude is referred to as a second area, and the area corresponding to a latitude range from the second latitude to 90° is referred to as a third area; mapping the first area to a first target image according to a first mapping method; mapping the second area to the second target image according to a second mapping method; mapping the third area to a third target image according to a third mapping method, and splicing the first target image, the second target image, and the third target image to obtain a two-dimensional plane image. By virtue of the above solution, the code rate required for coding is lowered.

### CROSS-REFERENCE TO RELATED APPLICATIONS

This application is a Continuation-in-Part of U.S. patent application Ser. No. 16/490,373 filed on Aug. 30, 2019, which claims the benefit to national stage filing under 35 U.S.C. § 371 of PCT/CN2017/098378, filed on Aug. 22, 2017 which claims priority to CN Application No. 201710116888.9 filed on Mar. 1, 2017. The applications are incorporated herein by reference in their entirety.

### FIELD

Embodiments of the present disclosure generally relate to the field of computer technologies, and more particularly relate to a panoramic image mapping method, a panoramic image mapping apparatus, and a panoramic image mapping device.

### BACKGROUND

With constant growth of virtual reality (VR) technologies, the demand on VR videos has been increasing in various fields. Compared with conventional plane images, 360° panoramic images require a wider angle-of-view. Therefore, the panoramic images require a higher resolution, and accordingly the code rate for coding the same becomes much higher.

The current coding and storing technologies do not support spheres yet, such that it is needed to map a 360° panoramic image to a two-dimensional plane and then code and store the image mapped on the two-dimensional plane.

Common approaches in conventional methods generally sample a sphere based on latitude-longitude of the sphere and then map the sphere to a two-dimensional plane. However, when mapping the 360° panoramic image in this manner, a relatively serious oversampling phenomenon occurs to high-latitude areas of the sphere, which increases the code rate required for coding.

### SUMMARY

Embodiments of the present disclosure provide a panoramic image mapping method, a panoramic image mapping apparatus, and a panoramic image mapping device so as to overcome the drawback in the prior art that a relatively serious oversampling phenomenon occurs to high-latitude areas of a sphere, which increases the code rate required for coding.

An embodiment of the present disclosure provides a panoramic image mapping method, comprising: obtaining a to-be-mapped panoramic image; splitting the to-be-mapped panoramic image into three areas according to a first latitude and a second latitude, wherein the area corresponding to a latitude range from −90° to the first latitude is referred to as a first area, the area corresponding to a latitude range from the first latitude to the second latitude is referred to as a second area, and the area corresponding to a latitude range from the second latitude to 90° is referred to as a third area, the value of the first latitude being greater than −90° but less than the value of the second latitude, the value of the second latitude being greater than the value of the first latitude, but less than 90°; mapping the first area to a first target image according to a first mapping method; mapping the second area to the second target image according to a second mapping method; mapping the third area to a third target image according to a third mapping method; and splicing the first target image, the second target image, and the third target image to obtain a two-dimensional plane image.

An embodiment of the present disclosure further provides a panoramic image reverse mapping method, comprising: obtaining a to-be-reversely-mapped two-dimension plane image; splitting the to-be-reversely-mapped two-dimensional plane image based on a preset splitting rule into a first target image, a second target image, and a third target image; reversely mapping the first target image to a first area of a panorama image; reversely mapping the second target image to a second area of a panorama image; reversely mapping the third target image to a third area of the panorama image; and splicing the first area, the second area, and the third area to obtain the panorama image.

An embodiment of the present disclosure provides a panoramic image mapping apparatus, comprising: a first obtaining module configured for obtaining a to-be-mapped panoramic image; a first splitting unit configured for splitting the to-be-mapped panoramic image into three areas according to a first latitude and a second latitude, wherein the area corresponding to a latitude range from −90° to the first latitude is referred to as a first area, the area corresponding to a latitude range from the first latitude to the second latitude is referred to as a second area, and the area corresponding to a latitude range from the second latitude to 90° is referred to as a third area, the value of the first latitude being greater than −90° but less than the value of the second latitude, the value of the second latitude being greater than the value of the first latitude, but less than 90°; a first mapping module configured for mapping the first area to a first target image according to a first mapping method; a second mapping module configured for mapping the second area to a second target image according to a second mapping method; a third mapping module configured for mapping the third area to a third target image according to a third mapping method; and a first splicing module configured for splicing the first target image, the second target image, and the third target image to obtain a two-dimensional plane image.

An embodiment of the present disclosure provides a panoramic image reverse mapping apparatus, comprising: a second obtaining module configured for obtaining a to-be-reversely-mapped two-dimension plane image; a second splitting module configured for splitting the to-be-reversely-mapped two-dimensional plane image based on a preset splitting rule into a first target image, a second target image, and a third target image; a first reverse mapping module configured for reversely mapping the first target image to a first area of a panorama image; a second reverse mapping module configured for reversely mapping the second target image to a second area of the panorama image; a third reverse mapping module configured for reversely mapping the third target image to a third area of the panorama image; and a second splicing module configured for splicing the first area, the second area, and the third area to obtain the panorama image.

An embodiment of the present disclosure provides a panoramic image mapping device, comprising: at least one processor; and a memory in communication connection with the at least one processor; wherein, the memory stores an instruction that may be executed by the at least one processor; the instruction is executed by the at least one processor, such that the at least one processor is capable of performing the panoramic image mapping method.

An embodiment of the present disclosure provides a panoramic image mapping device, comprising: at least one processor; and a memory in communication connection with the at least one processor; wherein, the memory stores an instruction that may be executed by the at least one processor; the instruction is executed by the at least one processor, such that the at least one processor is capable of performing the panoramic image reverse mapping method.

An embodiment of the present disclosure provides a computer readable memory medium on which an instruction is stored, wherein the instruction, when being executed, implements the steps of the panoramic image mapping method or the panoramic image reverse mapping method.

By adopting at least one embodiment above, the to-be-mapped panoramic image as obtained may be split into three portions, wherein each portion is mapped with a different mapping method, and then the mapped areas are spliced to obtain a two-dimensional plane image, which lowers the code rate needed for coding.

### BRIEF DESCRIPTION OF THE DRAWINGS

The drawings illustrated here are used for providing further understanding of the present disclosure, which constitute part of the present application. The exemplary embodiments of the present disclosure and their explanations are used for explaining the present disclosure, which do not constitute improper limitation of the present disclosure. In the drawings:

FIG. 1 shows a flow diagram of a panoramic image mapping method according to an embodiment of the present disclosure;

FIG. 2 shows an application diagram of a parameter determining manner according to an embodiment of the present disclosure;

FIG. 3 shows a schematic diagram of image splicing according to an embodiment of the present disclosure;

FIG. 4 shows a flow diagram of a panoramic image mapping method according to an embodiment of the present disclosure;

FIG. 5 shows a structural diagram of a panoramic image mapping device corresponding to FIG. 1 according to an embodiment of the present disclosure;

FIG. 6 shows a structural diagram of a panoramic image reverse mapping device corresponding to FIG. 4 according to an embodiment of the present disclosure; and

FIG. 7 shows a structural schematic diagram of a panoramic image mapping device according to an embodiment of the present disclosure.

### DETAILED DESCRIPTION OF EMBODIMENTS

To make the objects, technical solutions, and advantages of the present disclosure much clearer, the technical solutions of the present disclosure will be described clearly and sufficiently with reference to the embodiments and corresponding drawings of the present disclosure. Apparently, the embodiments described herein are only part of the embodiments of the present disclosure, not all of them. All other embodiments obtained by those skilled in the art without exercise of inventive work based on the embodiments in the present disclosure shall fall within the protection scope of the present disclosure.

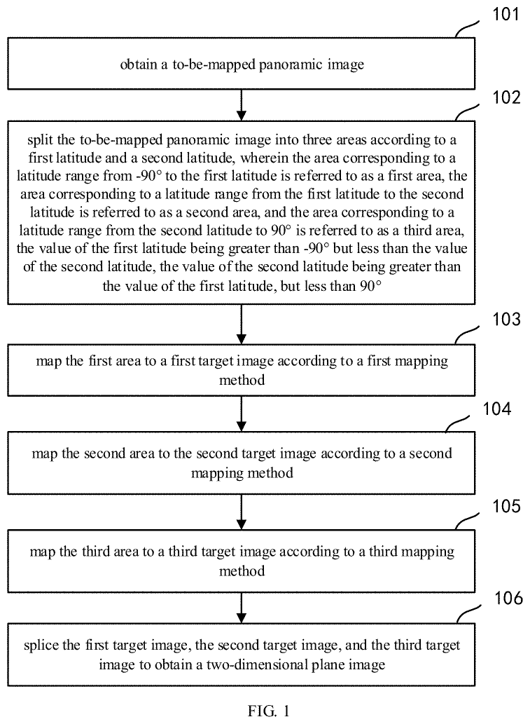

FIG. 1 shows a flow diagram of a panoramic image mapping method according to an embodiment of the present disclosure, which may specifically comprise steps of:

Step 101: obtaining a to-be-mapped panoramic image.

Specifically, the to-be-mapped panoramic image may include, but is not limited to, a longitude-latitude image, a cube mapping image, or a multi-channel camera acquired panoramic image. It may also be each frame of image in the panoramic video of a cube mapping image or acquired by multiple channels of cameras. Besides, the to-be-mapped panoramic image may optionally be a sphere.

Step 102: splitting the to-be-mapped panoramic image into three areas according to a first latitude and a second latitude, wherein the area corresponding to a latitude range from −90° to the first latitude is referred to as a first area, the area corresponding to a latitude range from the first latitude to the second latitude is referred to as a second area, and the area corresponding to a latitude range from the second latitude to 90° is referred to as a third area, the value of the first latitude being greater than −90° but less than the value of the second latitude, the value of the second latitude being greater than the value of the first latitude, but less than 90°.

The conventional methods of mapping a panoramic image to a two-dimensional plane image mostly adopt a same mapping method to different regions; because the size of a high-altitude area of the panoramic image might be different from those of other areas, adopting the same mapping method for different areas would likely cause oversampling of the high-latitude area, which increases the code rate required for coding and lowers coding efficiency.

In this embodiment, the to-be-mapped panoramic image is split into areas by altitudes, such that different latitude values may be set according to actual conditions so as to split the to-be-mapped panoramic image. For example, two latitude values may be set to split the to-be-mapped panoramic image into three areas. Three latitude values may also be set to split the to-be-mapped panoramic image into four areas, and so on.

Step 103: mapping the first area to a first target image according to a first mapping method;

Step 104: mapping the second area to the second target image according to a second mapping method;

Step 105: mapping the third area to a third target image according to a third mapping method;

Step 106: splicing the first target image, the second target image, and the third target image to obtain a two-dimensional plane image.

By mapping different mapping methods for different areas, they may be mapped to different target images. Particularly, the vertical resolutions of the mapped different target images are identical. The respective target images may be spliced based on their vertical resolutions to obtain a two-dimensional plane image.

By adopting the above solution, the to-be-mapped panoramic image as obtained may be split into three portions, wherein each portion is mapped with a different mapping method, and then the mapped areas are spliced to obtain a two-dimensional plane image, which lowers the code rate needed for coding.

Further, in an embodiment, the mapping the first area to a first target image according to a first mapping method may specifically comprise:

setting up a first initial target area, wherein the first initial target area is configured for mapping the panoramic image to a plane image; determining, for any pixel point in the first initial target area, a pixel value of corresponding latitude-longitude coordinates of the pixel point in the first area; and obtaining a first target image based on pixel values of corresponding latitude-longitude coordinates of respective pixel points in the first initial target area.

When mapping the first area, a first initial target area needs to be first set up; the size and location of the first initial target area are determined in advance using an algorithm. That is, it is known to which initial target area the first area is mapped. Then, the corresponding longitude-latitude coordinates in the first area are determined based on the coordinates of the pixel point in the first initial target area; and next, the pixel value of the longitude-latitude coordinates is obtained, which are set as the pixel value of the pixel point in the first initial target area. For each pixel point in the first initial target area, its pixel value is all determined using the method above to finally obtain the first target image. Particularly, the first target image may be square, i.e., the horizontal pixels and vertical pixels of the first target image are identical.

Additionally, in a preferred embodiment, the determining, for any pixel point in the first initial target area, a pixel value of corresponding latitude-longitude coordinates of the pixel point in the first area may specifically comprise:

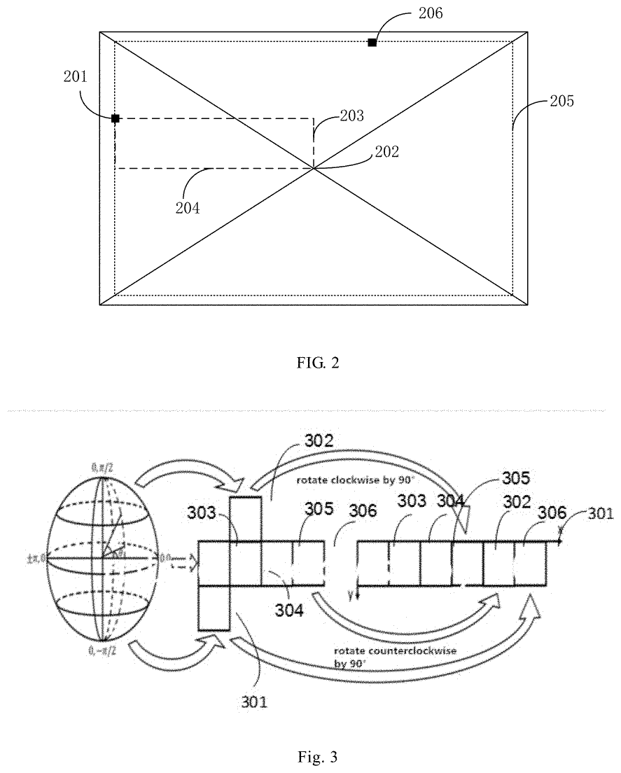

determining a first vertical distance 203 and a first horizontal distance 204 from the coordinates of the first target pixel point 201 to the geometric center 202 of the first initial target area, as shown in FIG. 2, which shows an application schematic diagram of a parameter determining manner according to an embodiment of the present application;

determining a larger one of the first vertical distance and the first horizontal distance to obtain a first parameter;

determining a first concentric image 205 where the first target pixel point is located;

selecting a first pixel point 206 in the first concentric image based on a preset rule;

determining a distance from the first target pixel point to the first pixel point to obtain a second parameter;

determining the corresponding latitude-longitude coordinates of the first target pixel point in the first area based on the first parameter and the second parameter; and obtaining the pixel value of the corresponding latitude-longitude coordinates of the first target pixel point in the first area.

When determining the corresponding longitude-latitude coordinates of the first target pixel point in the first area, two parameters need to be first determined; then, the corresponding longitude-latitude coordinates of the first target pixel point in the first area are determined based on the two parameters. Particularly, the first concentric image is a geometric image with the geometric center of the first initial target area as its center. Particularly, the second parameter refers to the distance from the first target pixel point to the first pixel point, wherein the position of the first pixel point may be randomly selected. The second parameter may be computed in a clockwise or counterclockwise manner. That is, the distance from the first target pixel point to the first pixel point may be computed in a clockwise or counterclockwise manner.

Additionally, the pixel value corresponding to the first target pixel point may be obtained by interpolation based on the pixel value surrounding the first target pixel point.

Additionally, in an embodiment, the determining a larger one of the first vertical distance and the first horizontal distance to obtain a first parameter may specifically comprise:

Determining a first parameter m₁ in the first vertical distance and the first horizontal distance based on the expression m₁=max(abs(W₁÷2−X₁−0.5),abs(W₁÷2−Y₁−0.5)), wherein the resolution of the first initial target area is W₁×W₁, (X₁, Y₁) denotes the coordinates of the first target pixel point;

the determining a distance from the first target pixel point to the first pixel point to obtain a second parameter further comprises:

according to the expression:

$${m}_{2} = ( {W}_{1} - 1 ) \div 2 - {m}_{1} ;$$

$${n}_{1} = \{ \begin{matrix}{X}_{1} + 0.5 - {m}_{2} & ( {Y}_{1} \leq {X}_{1} and {X}_{1} + {Y}_{1} < {W}_{1} ) \\ 2 \times {m}_{1} + {Y}_{1} + 0.5 - {m}_{2} & ( {Y}_{1} < {X}_{1} and {X}_{1} + {Y}_{1} \geq {W}_{1} ) \\ 4 \times {m}_{1} + {W}_{1} - ( {X}_{1} + 0.5 ) - {m}_{2} & ( {Y}_{1} \geq {X}_{1} and {X}_{1} + {Y}_{1} > {W}_{1} ) \\ 6 \times {m}_{1} + {W}_{1} - ( {Y}_{1} + 0.5 ) - {m}_{2} & ( {Y}_{1} > {X}_{1} and {X}_{1} + {Y}_{1} \leq {W}_{1} )\end{matrix}$$

determining a second parameter n₁;

and the determining the corresponding latitude-longitude coordinates of the first target pixel point in the first area based on the first parameter and the second parameter further comprises:

latitude₁=(Z₁+90°)×m₁÷(W₁÷2)−90;

longitude₁=n₁÷(8×m₁)×360°−180°,

where Z₁ is the first latitude, latitude₁ is the corresponding latitude of the first target pixel point in the first area, and longitude₁ is the corresponding longitude of the first target pixel point in the first area.

Further, in an embodiment, the mapping the second area to a second target image according to a second mapping method may specifically comprise:

setting up a second initial target area, wherein the second initial target area is a carrier for mapping the panoramic image to a plane image;

determining, for any pixel point in the second initial target area, a pixel value of corresponding latitude-longitude coordinates of the pixel point in the second area; and

obtaining a second target image based on pixel values of corresponding latitude-longitude coordinates of respective pixel points in the second initial target area.

When mapping the second area, a second initial target area needs to be first set up; the size and location of the second initial target area are determined in advance using an algorithm. That is, it is known to which initial target area the second area is mapped. Then, the corresponding longitude-latitude coordinates in the second area are determined based on the coordinates of the pixel point in the second initial target area; and next, the pixel value of the longitude-latitude coordinates is obtained, which are set as the pixel value of the pixel point in the second initial target area. For each pixel point in the second initial target area, its pixel value is all determined using the method above to finally obtain the second target image. Particularly, the second target image may be rectangular, i.e., the horizontal pixels and vertical pixels of the first target image are different.

Additionally, in a preferred embodiment, the determining, for any pixel point in the second initial target area, a pixel value of corresponding latitude-longitude coordinates of the pixel point in the second area may specifically comprise:

determining the corresponding latitude-longitude coordinates of the second target pixel point in the second area based on the first latitude and the second latitude; and obtaining the pixel value of the corresponding latitude-longitude coordinates of the second target pixel point in the second area.

The second area refers to an area with a relatively lower latitude range in the to-be-mapped panoramic image; besides, since the area of the to-be-mapped panoramic image in the second area has a relatively large size, the resolution of its corresponding second initial target area is also relatively high. Then, the pixel value of the corresponding second target pixel point in the second area is determined based on the first latitude and the second latitude selected on the to-be-mapped panoramic image. Additionally, the pixel value corresponding to the second target pixel point may be obtained by interpolation based on the pixel value surrounding the second target pixel point.

Additionally, in an embodiment, the determining the corresponding latitude-longitude coordinates of the second target pixel point in the second area based on the first latitude and the second latitude may specifically comprise:

according to the expression:

latitude₂=Z₂−(Z₂−Z₁)×(Y₂+0.5)÷H₂;

longitude₂=360°×(X₂+0.5)÷W₂−180°+offset

determining the corresponding latitude-longitude coordinates of the second target pixel point in the second area, wherein latitude₂ is the corresponding latitude of the second target pixel point in the second area, longitude₂ is the corresponding longitude of the second target pixel point in the second area, (X₂, Y₂) is the coordinates of the second target pixel point, Z₁ is the first latitude, Z₂ is the second latitude, the resolution of the second area is W₂×H₂, offset is the longitude corresponding to the geometric center of the second are, and the offset may be initiatively set based on actual scenarios.

Further, in an embodiment, the mapping the third area to a third target image according to a third mapping method may specifically comprise:

setting up a third initial target area, wherein the third initial target area is a carrier for mapping the panoramic image to a plane image; determining, for any pixel point in the third initial target area, a pixel value of corresponding latitude-longitude coordinates of the pixel point in the second area; and obtaining a third target image based on pixel values of corresponding latitude-longitude coordinates of respective pixel points in the third initial target area.

When mapping the third area, a third initial target area needs to be first set up; the size and location of the third initial target area are determined in advance using an algorithm. That is, it is known to which initial target area the third area is mapped. Then, the corresponding longitude-latitude coordinates in the third area are determined based on the coordinates of the pixel point in the third initial target area; and next, the pixel value of the longitude-latitude coordinates is obtained, which are set as the pixel value of the pixel point in the third initial target area. For each pixel point in the third initial target area, its pixel value is all determined using the method above to finally obtain the third target image. Particularly, the third target image may be square, i.e., the horizontal pixels and vertical pixels of the third target image are identical.

Additionally, in a preferred embodiment, the determining, for any pixel point in the third initial target area, a pixel value of corresponding latitude-longitude coordinates of the pixel point in the third area may specifically comprise:

determining, a second vertical distance and a second horizontal distance from the coordinates of the third target pixel point to the geometric center of the third initial target area;

determining a larger one of the second vertical distance and the second horizontal distance to obtain a third parameter;

determining a second concentric image where the third target pixel point is located;

selecting a second pixel point in the second concentric image based on a preset rule;

determining a distance from the third target pixel point to the second pixel point to obtain a fourth parameter;

determining the corresponding latitude-longitude coordinates of the third target pixel point in the third area based on the third parameter and the fourth parameter; and

obtaining the pixel value of the corresponding latitude-longitude coordinates of the third target pixel point in the third area.

When determining the corresponding longitude-latitude coordinates of the third target pixel point in the third area, two parameters need to be first determined; then, the corresponding longitude-latitude coordinates of the third target pixel point in the third area are determined based on the two parameters. Particularly, the second concentric image is a geometric image with the geometric center of the third initial target area as its center. Particularly, the fourth parameter refers to the distance from the third target pixel point to the second pixel point, wherein the position of the second pixel point may be randomly selected. The fourth parameter may be computed in a clockwise or counterclockwise manner. That is, the distance from the third target pixel point to the second pixel point may be computed in a clockwise or counterclockwise manner.

Additionally, the pixel value corresponding to the third target pixel point may be obtained by interpolation based on the pixel value surrounding the third target pixel point.

Additionally, in an embodiment, the determining a larger one of the second vertical distance and the second horizontal distance to obtain a third parameter may specifically comprise:

Determining a third parameter m₃ in the second vertical distance and the second horizontal distance based on the expression m₃=max(abs(W₃÷2−X₃−0.5),abs(W₃÷2−Y₃−0.5)), wherein the resolution of the third initial target area is W₃×W₃, (X₃, Y₃) denotes the coordinates of the third target pixel point;

the determining a distance from the third target pixel point to the second pixel point to obtain a fourth parameter further comprises:

according to the expression:

$${m}_{4} = ( {W}_{3} - 1 ) \div 2 - {m}_{3} ;$$

$${n}_{2} = \{ \begin{matrix}{X}_{3} + 0.5 - {m}_{4} & ( {Y}_{3} \leq {X}_{3} and {X}_{3} + {Y}_{3} < {W}_{3} ) \\ 2 \times {m}_{3} + {Y}_{3} + 0.5 - {m}_{4} & ( {Y}_{3} < {X}_{3} and {X}_{3} + {Y}_{3} \geq {W}_{3} ) \\ 4 \times {m}_{3} + {W}_{3} - ( {X}_{3} + 0.5 ) - {m}_{4} & ( {Y}_{3} \geq {X}_{3} and {X}_{3} + {Y}_{3} > {W}_{3} ) \\ 6 \times {m}_{3} + {W}_{3} - ( {Y}_{3} + 0.5 ) - {m}_{4} & ( {Y}_{3} > {X}_{3} and {X}_{3} + {Y}_{3} \leq {W}_{3} )\end{matrix}$$

determining the fourth parameter n₂;

the determining the corresponding latitude-longitude coordinates of the third target pixel point in the third area based on the third parameter and the fourth parameter further comprises:

latitude₃=90°−(90°−Z₂)×m₃÷(W₃÷2);

longitude₃=n₂÷(8×m₃)×360°−180°,

where Z₂ is the second latitude, latitude₃ is the corresponding latitude of the third target pixel point in the third area, and longitude₃ is the corresponding longitude of the third target pixel point in the third area.

Additionally, in a preferred embodiment, the splicing the first target image, the second target image, and the third target image to obtain a two-dimensional plane image may specifically comprise: splicing based on the resolutions of the first target image, the second target image, and the third target image to obtain the two-dimensional plane image.

FIG. 3 shows a schematic diagram of image splicing according to an embodiment of the present disclosure, which may specifically comprise:

For the first target image 301, the second target image, and the third target image 302, when the resolution of each image satisfies W₁=0.25×W₂=H₂=W₃, splicing may be performed as follows:

Due to 0.25×W₂=H₂, the resolution of the second target image may be expressed as 4H₂×H₂. The second target image may be split into four small planes with a resolution of H₂×H₂, denoted as a first target sub-image 303, a second target sub-image 304, a third target sub-image 305, and a fourth target sub-image 306. Then, splicing is done according to the sequence from the first target sub-image 303, the second target sub-image 304, the third target sub-image 305, the third target image 302, the fourth target sub-image 306, to the first target image 301 to form a two-dimensional plane image with resolution of 6W₁×W₁. Particularly, during splicing, the third target image is rotated clockwise by 90° and the fourth target sub-image is rotated counterclockwise by 90° to obtain a two-dimensional plane image with the resolution of 6W₁×W₁.

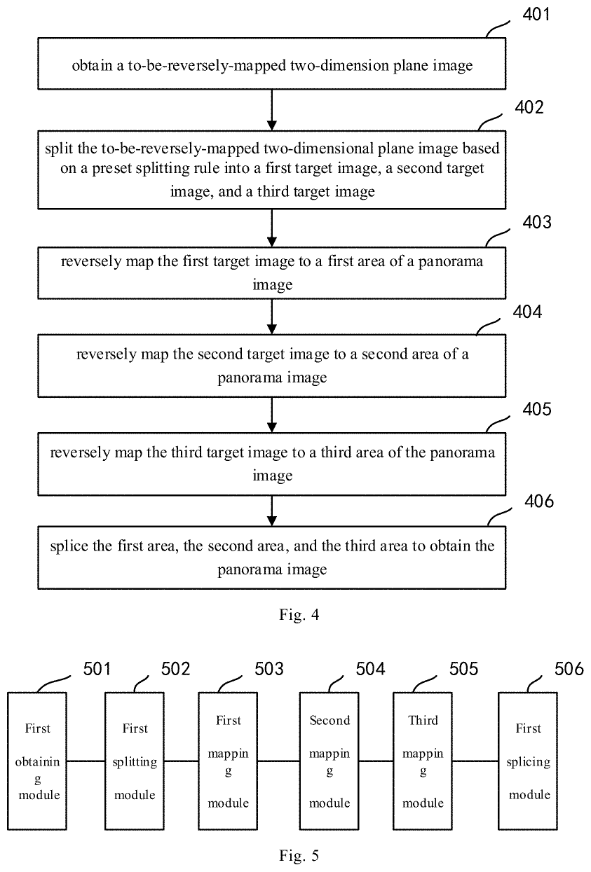

In another aspect, as shown in FIG. 4, an embodiment of the present disclosure further provides a flow diagram of a panoramic image reverse mapping method capable of mapping a two-dimensional plane image or video back to a sphere, which may specifically comprise:

Step 401: obtaining a to-be-reversely-mapped two-dimension plane image;

Step 402: splitting the to-be-reversely-mapped two-dimensional plane image based on a preset splitting rule into a first target image, a second target image, and a third target image;

Step 403: reversely mapping the first target image to a first area of a panorama image;

Step 404: reversely mapping the second target image to a second area of a panorama image;

Step 405: reversely mapping the third target image to a third area of a panorama image;

Step 406: splicing the first area, the second area, and the third area to obtain the panorama image.

For example, for the two-dimensional plane image with the resolution of 6W₁×W₁, which may be first split into 6 two-dimensional planes of W₁×W, denoted as a first sub-image, a second sub-image, a third sub-image, a fourth sub-image, a fifth sub-image, and a sixth sub-image, respectively, wherein the fourth sub-image is rotated counterclockwise by 90° to obtain the third target image; the sixth sub-image is the first target image; the remaining 4 sub-images are spliced in a sequence from the first sub-image, the second sub-image, the third sub-image, to the fifth sub-image to obtain the second target image.

For the pixel in the first area of the panoramic image, its corresponding coordinates in the first target image are computed based on its spherical longitude-latitude coordinates. The specific expression thereof is provided below:

$${m}_{1} = ( {W}_{1} \div 2 ) \times ( {latitude}_{1} + 90 ° ) \div ( {Z}_{1} + 90 ° ) . \\ {n}_{1} = 8 \times {m}_{1} \times ( longitude + 180 ° ) \div 360 ° . \\ \{ \begin{matrix}{X}_{1} = {n}_{1} + {m}_{2} - 0.5 & {Y}_{1} = {W}_{1} \div 2 - {m}_{1} - 0.5 \\ {X}_{1} = {W}_{1} \div 2 + {m}_{1} - 0.5 & {Y}_{1} = {n}_{1} + {m}_{2} - 2 \times {m}_{1} - 0.5 \\ {X}_{1} = 4 \times {m}_{1} - {n}_{1} - {m}_{2} + {W}_{1} - 0.5 & {Y}_{1} = {W}_{1} \div 2 + {m}_{1} - 0.5 \\ {X}_{1} = {W}_{1} \div 2 - {m}_{1} - 0.5 & {Y}_{1} = 6 \times {m}_{1} - {n}_{1} - {m}_{2} + {W}_{1} - 0.5\end{matrix}$$

where m₂=(W₁−1)÷2−m₁, (X₁, Y₁) denotes the coordinates in the first target image, (latitude₁, longitude₁) denotes the longitude-latitude coordinates in the first area, and the pixel of the first target image is W₁×W₁.

For the pixel in the second area of the panoramic image, its corresponding coordinates in the second target image are computed based on its spherical longitude-latitude coordinates. The specific expression thereof is provided below:

Y₂=(Z₂−latitude₂)×H₂÷(Z₂−Z₁)−0.5.

X₂=(longitude₂+180°−offset)÷360°×W₂−0.5

where (latitude₂,longitude₂) is the longitude-latitude coordinates in the second area, (X₂, Y₂) is the coordinates in the second target image, offset is the longitude corresponding to the geometric center of the second target image, the resolution of the second target image is W₂×H₂, Z₁ is the first latitude, and Z₂ is the second latitude.

For the pixel in the third area of the panoramic image, its corresponding coordinates in the third target image are computed based on its spherical longitude-latitude coordinates. The specific expression thereof is provided below:

$${m}_{3} = ( {W}_{3} \div 2 ) \times ( 90 ° - {latitude}_{3} ) \div ( 90 ° - {Z}_{2} ) . \\ {n}_{2} = 8 \times {m}_{3} \times ( longitude + 180 ° ) \div 360 ° . \\ {m}_{4} = ( {W}_{3} - 1 ) \div 2 - {m}_{3} . \\ \{ \begin{matrix}{Y}_{3} = {n}_{2} + {m}_{4} - 0.5 & {X}_{3} = {W}_{3} \div 2 - {m}_{3} - 0.5 & ( {n}_{2} < 2 \times {m}_{3} ) \\ {Y}_{3} = {W}_{3} \div 2 + {m}_{3} - 0.5 & {X}_{3} = {n}_{2} + {m}_{4} - 2 \times {m}_{3} - 0.5 & ( 2 \times {m}_{3} \leq {n}_{2} \leq 4 \times {m}_{3} ) \\ {Y}_{3} = 4 \times {m}_{3} - {n}_{2} - {m}_{4} + {W}_{3} - 0.5 & {X}_{3} = {W}_{3} \div 2 + {m}_{3} - 0.5 & ( 4 \times {m}_{3} \leq {n}_{2} \leq 6 \times {m}_{3} ) \\ {Y}_{3} = {W}_{3} \div 2 - {m}_{3} - 0.5 & {X}_{3} = 6 \times {m}_{3} - {n}_{2} - {m}_{4} + {W}_{3} - 0.5 & ( 6 \times {m}_{3} \leq {n}_{2} \leq 8 \times {m}_{3} )\end{matrix} ,$$

where (latitude₃,longitude₃) is the longitude-latitude coordinates in the third area, (X₃, Y₃) is the coordinates in the third target image, and the pixel of the third target image is W₃×W₃.

Till now, all steps of the reverse mapping method according to the present disclosure are completed. By reversely mapping the two-dimensional plane image back to the panoramic image through the reverse mapping method, it facilitates rendering and viewing. The method of the present disclosure enhances the coding efficiency by over 10% relative to other mapping methods.

Based on the same idea, an embodiment of the present disclosure further provides an apparatus corresponding to the method.

FIG. 5 shows a structural diagram of a panoramic image mapping device corresponding to FIG. 1 according to an embodiment of the present disclosure. As shown in FIG. 5, the apparatus may comprise:

a first obtaining module 501 configured for obtaining a to-be-mapped panoramic image;

a first splitting unit 502 configured for splitting the to-be-mapped panoramic image into three areas according to a first latitude and a second latitude, wherein the area corresponding to a latitude range from −90° to the first latitude is referred to as a first area, the area corresponding to a latitude range from the first latitude to the second latitude is referred to as a second area, and the area corresponding to a latitude range from the second latitude to 90° is referred to as a third area, the value of the first latitude being greater than −90° but less than the value of the second latitude, the value of the second latitude being greater than the value of the first latitude, but less than 90°;

a first mapping module 503 configured for mapping the first area to a first target image according to a first mapping method;

a second mapping module 504 configured for mapping the second area to a second target image according to a second mapping method;

a third mapping module 505 configured for mapping the third area to a third target image according to a third mapping method; and

a first splicing module 506 configured for splicing the first target image, the second target image, and the third target image to obtain a two-dimensional plane image.

In an embodiment of the present disclosure, the apparatus may further comprise:

a configuration information obtaining module configured for obtaining state switch configuration information configured by a configuration server, the status switch configuration information including status name, event name, and status switch information;

a first identifier generating module configured for forming a first identifier of the status switch information, and storing the first identifier and the status switch information to a status switch information table.

In an embodiment of the present disclosure, the status switch information specifically comprises: original status, target status, and interface name, and wherein the status switch module may specifically comprise:

an implementation class determining unit configured for determining an implementation class corresponding to the interface name based on a pre-stored interface implementation class correspondence table;

a process switch unit configured for switching the state of the scene interaction process based on the determined implementation class corresponding to the interface name.

In an embodiment of the present disclosure, the apparatus may further comprise: an implementation class obtaining unit configured for obtaining an implementation class corresponding to the interface name configured by the configuration server, wherein the implementation class includes an implementation method of the interface, an interface name, and state machine name to which the interface belongs; and a second identifier generating unit configured for forming a second identifier of the implementation method of the interface based on the interface name and the state machine name, and storing the second identifier and the implementation method of the interface to the interface implementation class corresponding table.

In a preferred embodiment, the first mapping module may specifically comprise: a first setup unit configured for setting up a first initial target area, wherein the first initial target area is a carrier for mapping the panoramic image to a plane image; a first determining unit configured for determining, for any pixel point in the first initial target area, a pixel value of corresponding latitude-longitude coordinates of the pixel point in the first area; and a first obtaining unit configured for obtaining a first target image based on pixel values of corresponding latitude-longitude coordinates of respective pixel points in the first initial target area.

In a preferred embodiment, the first determining unit may specifically comprise: determining, a first vertical distance and a first horizontal distance from the coordinates of the first target pixel point to the geometric center of the first initial target area; determining a larger one of the first vertical distance and the first horizontal distance to obtain a first parameter; determining a first concentric image where the first target pixel point is located; selecting a first pixel point in the first concentric image based on a preset rule; determining a distance from the first target pixel point to the first pixel point to obtain a second parameter; determining the corresponding latitude-longitude coordinates of the first target pixel point in the first area based on the first parameter and the second parameter; and obtaining the pixel value of the corresponding latitude-longitude coordinates of the first target pixel point in the first area.

In an embodiment, the determining a larger one of the first vertical distance and the first horizontal distance to obtain a first parameter may specifically comprise:

Determining a first parameter m₁ in the first vertical distance and the first horizontal distance based on the expression m₁=max(abs(W₁÷2−X₁−0.5),abs(W₁÷2−Y₁−0.5)), wherein the resolution of the first initial target area is W₁×W₁, (X₁, Y₁) denotes the coordinates of the first target pixel point;

the determining a distance from the first target pixel point to the first pixel point to obtain a second parameter further comprises:

according to the expression:

$${m}_{2} = ( {W}_{1} - 1 ) \div 2 - {m}_{1} . \\ {n}_{1} = \{ \begin{matrix}{X}_{1} + 0.5 - {m}_{2} & ( {Y}_{1} \leq {X}_{1} and {X}_{1} + {Y}_{1} < {W}_{1} ) \\ 2 \times {m}_{1} + {Y}_{1} + 0.5 - {m}_{2} & ( {Y}_{1} < {X}_{1} and {X}_{1} + {Y}_{1} \geq {W}_{1} ) \\ 4 \times {m}_{1} + {W}_{1} - ( {X}_{1} + 0.5 ) - {m}_{2} & ( {Y}_{1} \geq {X}_{1} and {X}_{1} + {Y}_{1} > {W}_{1} ) \\ 6 \times {m}_{1} + {W}_{1} - ( {Y}_{1} + 0.5 ) - {m}_{2} & ( {Y}_{1} > {X}_{1} and {X}_{1} + {Y}_{1} \leq {W}_{1} )\end{matrix}$$

determining a second parameter n₁;

and the determining the corresponding latitude-longitude coordinates of the first target pixel point in the first area based on the first parameter and the second parameter further comprises:

latitude₁=(Z₁+90°)×m₁÷(W₁÷2)−90.

longitude₁=n₁÷(8×m₁)×360°−180°,

where Z₁ is the first latitude, latitude₁ is the corresponding latitude of the first target pixel point in the first area, and longitude₁ is the corresponding longitude of the first target pixel point in the first area.

In a preferred embodiment, the second mapping module may specifically comprise: a second setup unit configured for setting up a second initial target area, wherein the second initial target area is a carrier for mapping the panoramic image to a plane image; a second determining unit configured for determining, for any pixel point in the second initial target area, a pixel value of corresponding latitude-longitude coordinates of the pixel point in the second area; and a second obtaining unit configured for obtaining a second target image based on pixel values of corresponding latitude-longitude coordinates of respective pixel points in the second initial target area.

In a preferred embodiment, the second determining unit may specifically comprise: determining the corresponding latitude-longitude coordinates of the second target pixel point in the second area based on the first latitude and the second latitude; and obtaining the pixel value of the corresponding latitude-longitude coordinates of the second target pixel point in the second area.

In an embodiment, the determining the corresponding latitude-longitude coordinates of the second target pixel point in the second area based on the first latitude and the second latitude may specifically comprise:

according to the expression:

latitude₂=Z₂−(Z₂−Z₁)×(Y₂+0.5)÷H₂.

longitude₂=360°×(X₂+0.5)÷W₂−180°+offset

determining the corresponding latitude-longitude coordinates of the second target pixel point in the second area, wherein latitude₂ is the corresponding latitude of the second target pixel point in the second area, longitude₂ is the corresponding longitude of the second target pixel point in the second area, (X₂, Y₂) is the coordinates of the second target pixel point, Z₁ is the first latitude, Z₂ is the second latitude, the resolution of the second area is W₂×H₂, offset is the longitude corresponding to the geometric center of the second area.

In a preferred embodiment, the third mapping module may specifically comprise: a third setup unit configured for setting up a third initial target area, wherein the third initial target area is a carrier for mapping the panoramic image to a plane image; a third determining unit configured for determining, for any pixel point in the third initial target area, a pixel value of corresponding latitude-longitude coordinates of the pixel point in the third area; and a third obtaining unit configured for obtaining a third target image based on pixel values of corresponding latitude-longitude coordinates of respective pixel points in the third initial target area.

In a preferred embodiment, the third determining unit may specifically comprise: determining, a second vertical distance and a second horizontal distance from the coordinates of the third target pixel point to the geometric center of the third initial target area; determining a larger one of the second vertical distance and the second horizontal distance to obtain a third parameter; determining a second concentric image where the third target pixel point is located; selecting a second pixel point in the second concentric image based on a preset rule; determining a distance from the third target pixel point to the second pixel point to obtain a fourth parameter; determining the corresponding latitude-longitude coordinates of the third target pixel point in the third area based on the third parameter and the fourth parameter; and obtaining the pixel value of the corresponding latitude-longitude coordinates of the third target pixel point in the third area.

In an embodiment, the determining a larger one of the second vertical distance and the second horizontal distance to obtain a third parameter may specifically comprise:

Determining a third parameter m₃ in the second vertical distance and the second horizontal distance based on the expression m₃=max(abs(W₃÷2−X₃−0.5), abs(W₃÷2−Y₃−0.5)), wherein the resolution of the third initial target area is W₃×W₃, (X₃, Y₃) denotes the coordinates of the third target pixel point;

the determining a distance from the third target pixel point to the second pixel point to obtain a fourth parameter further comprises:

according to the expression:

$${m}_{4} = ( {W}_{3} - 1 ) \div 2 - {m}_{3} . \\ {n}_{1} = \{ \begin{matrix}{X}_{3} + 0.5 - {m}_{4} & ( {Y}_{3} \leq {X}_{3} and {X}_{3} + {Y}_{3} < {W}_{3} ) \\ 2 \times {m}_{3} + {Y}_{3} + 0.5 - {m}_{4} & ( {Y}_{3} < {X}_{3} and {X}_{3} + {Y}_{3} \geq {W}_{3} ) \\ 4 \times {m}_{3} + {W}_{3} - ( {X}_{3} + 0.5 ) - {m}_{4} & ( {Y}_{3} \geq {X}_{3} and {X}_{3} + {Y}_{3} > {W}_{3} ) \\ 6 \times {m}_{3} + {W}_{3} - ( {Y}_{3} + 0.5 ) - {m}_{4} & ( {Y}_{3} > {X}_{3} and {X}_{3} + {Y}_{3} \leq {W}_{3} )\end{matrix}$$

determining the fourth parameter n₂;

the determining the corresponding latitude-longitude coordinates of the third target pixel point in the third area based on the third parameter and the fourth parameter may specifically comprise:

latitude₃=90°−(90°−Z₂)×m₃÷(W₃÷2).

longitude₃=n₂÷(8×m₃)×360°−180°,

where Z₂ is the second latitude, latitude₃ is the corresponding latitude of the third target pixel point in the third area, and longitude₃ is the corresponding longitude of the third target pixel point in the third area.

In a preferred embodiment, the splicing the first target image, the second target image, and the third target image to obtain a two-dimensional plane image may specifically comprise: splicing based on the resolutions of the first target image, the second target image, and the third target image to obtain the two-dimensional plane image.

Based on the same idea, an embodiment of the present disclosure further provides an apparatus corresponding to the method.

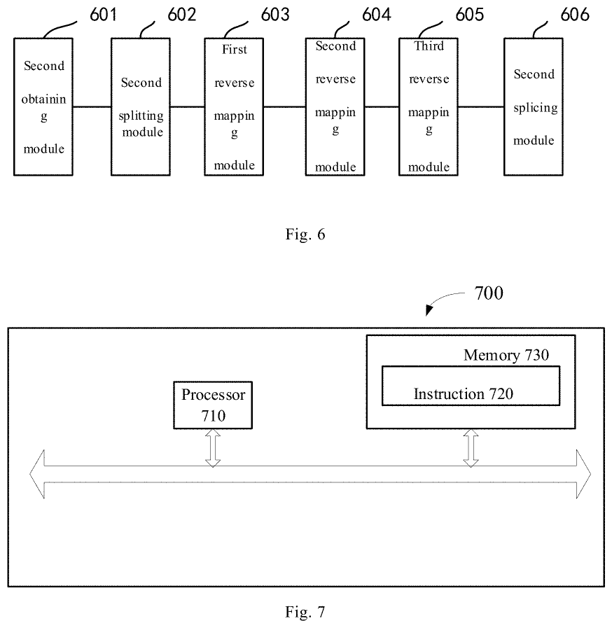

FIG. 6 shows a structural diagram of a panoramic image reverse mapping device corresponding to FIG. 4 according to an embodiment of the present disclosure. As shown in FIG. 6, the apparatus may comprise:

a second obtaining module 601 configured for obtaining a to-be-reversely-mapped two-dimension plane image;

a second splitting module 602 configured for splitting the to-be-reversely-mapped two-dimensional plane image based on a preset splitting rule into a first target image, a second target image, and a third target image;

a first reverse mapping module 603 configured for reversely mapping the first target image to a first area of a panorama image;

a second reverse mapping module 604 configured for reversely mapping the second target image to a second area of the panorama image;

a third reverse mapping module 605 configured for reversely mapping the third target image to a third area of the panorama image; and

a second splicing module 606 configured for splicing the first area, the second area, and the third area to obtain the panorama image.

FIG. 7 shows a structural diagram of a panoramic image mapping device corresponding to FIG. 1 according to an embodiment of the present disclosure. As shown in FIG. 7, the device 700 may comprise:

at least one processor 701; and

a memory 730 in communication connection with the at least one processor; wherein,

the memory 730 stores an instruction 720 that may be executed by the at least one processor 710, the instruction being executed by the at least processor 710 such that the at least one processor 710 may implement the above embodiments of the panoramic image mapping method. Implementation of specific functions of the device 400 may refer to the explanations on the method embodiments above, which will not be detailed here.

Additionally, the memory 730 stores an instruction 720 that may be executed by the at least one processor 710, the instruction being executed by the at least processor 710 such that the at least one processor 710 may implement the above embodiments of the panoramic image reverse mapping method. Implementation of specific functions of the device 400 may refer to the explanations on the method embodiments above, which will not be detailed here.

Based on a same idea, an embodiment of the present disclosure further provides a computer readable memory medium on which an instruction is stored, wherein the instruction, when being executed, implements the steps of the panoramic image mapping method or the panoramic image reverse mapping method.

Additionally, other identical elements are also present. Those skilled in the art should understand that the embodiments of the present disclosure may be provided as a method, a system, or a computer program product. Therefore, the present disclosure may adopt a form of complete hardware embodiment, a complete software embodiment, or an embodiment combining software and hardware. Moreover, the present disclosure may adopt a form of a computer program product implemented on one or more computer-adaptable storage media including computer-adaptable program code (including, but not limited to, a magnetic disc memory, CD-ROM, and optical memory, etc.). What have been described above are only preferred embodiments of the present disclosure, not for limiting the present disclosure; to those skilled in the art, the present disclosure may have various alterations and changes. Any modifications, equivalent substitutions, and improvements within the spirit and principle of the present disclosure should be included within the protection scope of the present disclosure.

I/We claim:

1. A panoramic image mapping method, comprising:
obtaining a to-be-mapped panoramic image;
splitting the to-be-mapped panoramic image into three areas according to a first latitude and a second latitude, wherein the area corresponding to a latitude range from −90° to the first latitude is referred to as a first area, the area corresponding to a latitude range from the first latitude to the second latitude is referred to as a second area, and the area corresponding to a latitude range from the second latitude to 90° is referred to as a third area, the value of the first latitude being greater than −90° but less than the value of the second latitude, the value of the second latitude being greater than the value of the first latitude, but less than 90°;
mapping the first area to a first target image according to a first mapping method;
mapping the second area to the second target image according to a second mapping method;
mapping the third area to a third target image according to a third mapping method;
and splicing the first target image, the second target image, and the third target image to obtain a two-dimensional plane image.

2. The method according to claim 1, wherein the mapping the first area to a first target image according to a first mapping method further comprises:
setting up a first initial target area, wherein the first initial target area is a carrier for mapping the panoramic image to a plane image;
determining, for any pixel point in the first initial target area, a pixel value of corresponding latitude-longitude coordinates of the pixel point in the first area; and
obtaining a first target image based on pixel values of corresponding latitude-longitude coordinates of respective pixel points in the first initial target area.

3. The method according to claim 2, wherein the determining, for any pixel point in the first initial target area, a pixel value of corresponding latitude-longitude coordinates of the pixel point in the first area further comprises:
determining, a first vertical distance and a first horizontal distance from the coordinates of the first target pixel point to the geometric center of the first initial target area;
determining a larger one of the first vertical distance and the first horizontal distance to obtain a first parameter;
determining a first concentric image where the first target pixel point is located;
selecting a first pixel point in the first concentric image based on a preset rule;
determining a distance from the first target pixel point to the first pixel point to obtain a second parameter;
determining the corresponding latitude-longitude coordinates of the first target pixel point in the first area based on the first parameter and the second parameter; and
obtaining the pixel value of the corresponding latitude-longitude coordinates of the first target pixel point in the first area.

4. The method according to claim 3, wherein the determining a larger one of the first vertical distance and the first horizontal distance to obtain a first parameter further comprises:
determining a first parameter m₁ in the first vertical distance and the first horizontal distance based on the expression m₁=max(abs(W₁÷2−X₁−0.5),abs(W₁÷2−Y₁−0.5)), wherein the resolution of the first initial target area is W₁×W₁, (X₁, Y₁) denotes the coordinates of the first target pixel point;
the determining a distance from the first target pixel point to the first pixel point to obtain a second parameter further comprises:
according to the expression:
$${m}_{2} = ( {W}_{1} - 1 ) \div 2 - {m}_{1} ;$$
$${n}_{1} = \{ \begin{matrix}{X}_{1} + 0.5 - {m}_{2} & ( {Y}_{1} \leq {X}_{1} and {X}_{1} + {Y}_{1} < {W}_{1} ) \\ 2 \times {m}_{1} + {Y}_{1} + 0.5 - {m}_{2} & ( {Y}_{1} < {X}_{1} and {X}_{1} + {Y}_{1} \geq {W}_{1} ) \\ 4 \times {m}_{1} + {W}_{1} - ( {X}_{1} + 0.5 ) - {m}_{2} & ( {Y}_{1} \geq {X}_{1} and {X}_{1} + {Y}_{1} > {W}_{1} ) \\ 6 \times {m}_{1} + {W}_{1} - ( {Y}_{1} + 0.5 ) - {m}_{2} & ( {Y}_{1} > {X}_{1} and {X}_{1} + {Y}_{1} \leq {W}_{1} )\end{matrix}$$
determining a second parameter n₁;
and the determining the corresponding latitude-longitude coordinates of the first target pixel point in the first area based on the first parameter and the second parameter further comprises:
latitude₁=(Z₁+90°)×m₁÷(W₁÷2)−90;
longitude₁=n₁÷(8×m₁)×360°−180°,
where Z₁ is the first latitude, latitude₁ is the corresponding latitude of the first target pixel point in the first area and longitude₁ is the corresponding longitude of the first target pixel point in the first area.

5. The method according to claim 1, wherein the mapping the second area to a second target image according to a second mapping method further comprises:
setting up a second initial target area, wherein the second initial target area is a carrier for mapping the panoramic image to a plane image;
determining, for any pixel point in the second initial target area, a pixel value of corresponding latitude-longitude coordinates of the pixel point in the second area; and
obtaining a second target image based on pixel values of corresponding latitude-longitude coordinates of respective pixel points in the second initial target area.

6. The method according to claim 5, wherein the determining, for any pixel point in the second initial target area, a pixel value of corresponding latitude-longitude coordinates of the pixel point in the second area further comprises:
determining the corresponding latitude-longitude coordinates of the second target pixel point in the second area based on the first latitude and the second latitude; and
obtaining the pixel value of the corresponding latitude-longitude coordinates of the second target pixel point in the second area.

7. The method according to claim 6, wherein the determining the corresponding latitude-longitude coordinates of the second target pixel point in the second area based on the first latitude and the second latitude further comprises:
according to the expression:
latitude₂=Z₂−(Z₂−Z₁)×(Y₂+0.5)÷H₂;
longitude₂=360°×(X₂+0.5)÷W₂−180°+offset
determining the corresponding latitude-longitude coordinates of the second target pixel point in the second area, wherein latitude₂ is the corresponding latitude of the second target pixel point in the second area, longitude₂ is the corresponding longitude of the second target pixel point in the second area, (X₂, Y₂) is the coordinates of the second target pixel point, Z₁ is the first latitude, Z₂ is the second latitude, the resolution of the second area is W₂×H₂, and offset is the longitude corresponding to the geometric center of the second area.

8. The method according to claim 1, wherein the mapping the third area to a third target image according to a third mapping method further comprises:
setting up a third initial target area, wherein the third initial target area is a carrier for mapping the panoramic image to a plane image;
determining, for any pixel point in the third initial target area, a pixel value of corresponding latitude-longitude coordinates of the pixel point in the second area; and
obtaining a third target image based on pixel values of corresponding latitude-longitude coordinates of respective pixel points in the third initial target area.

9. The method according to claim 8, wherein the determining, for any pixel point in the third initial target area, a pixel value of corresponding latitude-longitude coordinates of the pixel point in the third area further comprises:
determining, a second vertical distance and a second horizontal distance from the coordinates of the third target pixel point to the geometric center of the third initial target area;
determining a larger one of the second vertical distance and the second horizontal distance to obtain a third parameter;
determining a second concentric image where the third target pixel point is located;
selecting a second pixel point in the second concentric image based on a preset rule;
determining a distance from the third target pixel point to the second pixel point to obtain a fourth parameter;
determining the corresponding latitude-longitude coordinates of the third target pixel point in the third area based on the third parameter and the fourth parameter; and
obtaining the pixel value of the corresponding latitude-longitude coordinates of the third target pixel point in the third area.

10. The method according to claim 9, wherein the determining a larger one of the second vertical distance and the second horizontal distance to obtain a third parameter further comprises:
determining a third parameter m₃ in the second vertical distance and the second horizontal distance based on the expression m₃=max(abs(W₃÷2−X₃−0.5),abs(W₃÷2−Y₃−0.5)), wherein the resolution of the third initial target area is W₃×W₃, (X₃, Y₃) denotes the coordinates of the third target pixel point;
the determining a distance from the third target pixel point to the second pixel point to obtain a fourth parameter further comprises:
according to the expression:
$${m}_{2} = ( {W}_{3} - 1 ) \div 2 - {m}_{3} ;$$
$${n}_{2} = \{ \begin{matrix}{X}_{3} + 0.5 - {m}_{4} & ( {Y}_{3} \leq {X}_{3} and {X}_{3} + {Y}_{3} < {W}_{3} ) \\ 2 \times {m}_{3} + {Y}_{3} + 0.5 - {m}_{4} & ( {Y}_{3} < {X}_{3} and {X}_{3} + {Y}_{3} \geq {W}_{3} ) \\ 4 \times {m}_{3} + {W}_{3} - ( {X}_{3} + 0.5 ) - {m}_{4} & ( {Y}_{3} \geq {X}_{3} and {X}_{3} + {Y}_{3} > {W}_{3} ) \\ 6 \times {m}_{3} + {W}_{3} - ( {Y}_{3} + 0.5 ) - {m}_{4} & ( {Y}_{3} > {X}_{3} and {X}_{3} + {Y}_{3} \leq {W}_{3} )\end{matrix}$$
determining the fourth parameter n₂;
the determining the corresponding latitude-longitude coordinates of the third target pixel point in the third area based on the third parameter and the fourth parameter further comprises:
latitude₃=90°−(90°−Z₂)×m₃÷(W₃÷2);
longitude₃=n₂÷(8×m₃)×360°−180°,
where Z₂ is the second latitude, latitude₃ is the corresponding latitude of the third target pixel point in the third area, and longitude₃ is the corresponding longitude of the third target pixel point in the third area.

11. The method according to claim 9, wherein the splicing the first target image, the second target image, and the third target image to obtain a two-dimensional plane image further comprises: splicing based on the resolutions of the first target image, the second target image, and the third target image to obtain the two-dimensional plane image.

12. A panoramic image reverse mapping method, comprising:
obtaining a to-be-reversely-mapped two-dimension plane image;
splitting the to-be-reversely-mapped two-dimensional plane image based on a preset splitting rule into a first target image, a second target image, and a third target image;
reversely mapping the first target image to a first area of a panorama image;
reversely mapping the second target image to a second area of a panorama image;
reversely mapping the third target image to a third area of the panorama image; and
splicing the first area, the second area, and the third area to obtain the panorama image.

13. A panoramic image mapping apparatus, comprising:
a first obtaining module configured for obtaining a to-be-mapped panoramic image;
a first splitting unit configured for splitting the to-be-mapped panoramic image into three areas according to a first latitude and a second latitude, wherein the area corresponding to a latitude range from −90° to the first latitude is referred to as a first area, the area corresponding to a latitude range from the first latitude to the second latitude is referred to as a second area, and the area corresponding to a latitude range from the second latitude to 90° is referred to as a third area, the value of the first latitude being greater than −90° but less than the value of the second latitude, the value of the second latitude being greater than the value of the first latitude, but less than 90°;
a first mapping module configured for mapping the first area to a first target image according to a first mapping method;
a second mapping module configured for mapping the second area to a second target image according to a second mapping method;
a third mapping module configured for mapping the third area to a third target image according to a third mapping method; and
a first splicing module configured for splicing the first target image, the second target image, and the third target image to obtain a two-dimensional plane image.

14. A panoramic image reverse mapping apparatus, comprising:
a second obtaining module configured for obtaining a to-be-reversely-mapped two-dimension plane image;
a second splitting module configured for splitting the to-be-reversely-mapped two-dimensional plane image based on a preset splitting rule into a first target image, a second target image, and a third target image;
a first reverse mapping module configured for reversely mapping the first target image to a first area of a panorama image;
a second reverse mapping module configured for reversely mapping the second target image to a second area of the panorama image;
a third reverse mapping module configured for reversely mapping the third target image to a third area of the panorama image; and
a second splicing module configured for splicing the first area, the second area, and the third area to obtain the panorama image.

15. A panoramic image mapping device, comprising:
at least one processor; and
a memory in communication connection with the at least one processor; wherein,
the memory stores an instruction that may be executed by the at least one processor;
the instruction is executed by the at least one processor, such that the at least one processor is capable of performing the panoramic image mapping method according to claim 1.

16. A panoramic image mapping device, comprising:
at least one processor; and
a memory in communication connection with the at least one processor; wherein,
the memory stores an instruction that may be executed by the at least one processor;
the instruction is executed by the at least one processor, such that the at least one processor is capable of performing the panoramic image reverse mapping method according to claim 12.

17. A computer-readable memory medium, wherein an instruction is stored on the computer-readable storage medium, the instruction, when being executed by the processor, implements steps of claim 1.
